(19) United States
(12) Patent Application Publication
(10) Pub. No.: US 2013/0050433 A1
(43) Pub. Date: Feb. 28, 2013

(54) CONTROL COMPUTER AND METHOD FOR MONITORING SAFETY OF PARKING UNITS

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/494,955

(22) Filed: Jun. 12, 2012

(30) Foreign Application Priority Data
Aug. 30, 2011 (TW) 100131164

(51) Int. Cl. H04N 13/02

(52) U.S. Cl. 348/47; 348/E13.074

(57) ABSTRACT

A method for monitoring safety of a moving parking unit in a mechanical parking system using a control computer, digital images are captured by one or more image capturing devices positioned on the moving parking unit. The method detects a three dimensional (3D) figure area in each digital image, and controls area safety device to cut of power suppliers of the moving parking unit if the 3D figure area has been detected. The method further outputs alarm messages by lighting one or more signal lamps of the mechanical parking system.

### BACKGROUND

1. Technical Field

Embodiments of the present disclosure relate to surveillance technology, and particularly to a control computer and method for monitoring safety of persons around parking units being moved in a mechanical parking system using the control computer.

2. Description of Related Art

Mechanical parking systems (i.e., automatic parking system) have been used to park vehicles on a plurality of parking units (or called parking bays). The automatic parking system can be positioned in large buildings so that people have easy time to find parking spaces and spend little time physically parking the car itself. However, the mechanical parking system of related art cannot detect when a person walks into an operation area of the parking units when the parking units are moving. If the movement of the parking units are not stopped in time, the person may be injured. Therefore, an efficient method for monitoring safety of parking units moved in a mechanical parking system is desired.

### BRIEF DESCRIPTION OF THE DRAWINGS

FIG. 1 is a schematic diagram of one embodiment of a control computer electronically connected with a plurality of parking units.

FIG. 2 is a schematic diagram of one embodiment of the control computer including a parking unit monitoring system.

FIG. 3 is a schematic diagram of function modules of the parking unit monitoring system included in the control computer.

FIG. 4 is a flowchart of one embodiment of a method for monitoring safety of parking units moved in a mechanical parking system using the control computer.

FIG. 5 is a schematic diagram of an example of a parking unit.

FIG. 6 is a schematic diagram of an example of a mechanical parking system including a plurality of parking units.

FIG. 7 and FIG. 8 show examples of captured three dimensional (3D) images using an image capturing device positioned on the parking unit.

FIG. 9 is a schematic diagram of an example for issuing an alarm message when a person is detected near the parking unit.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

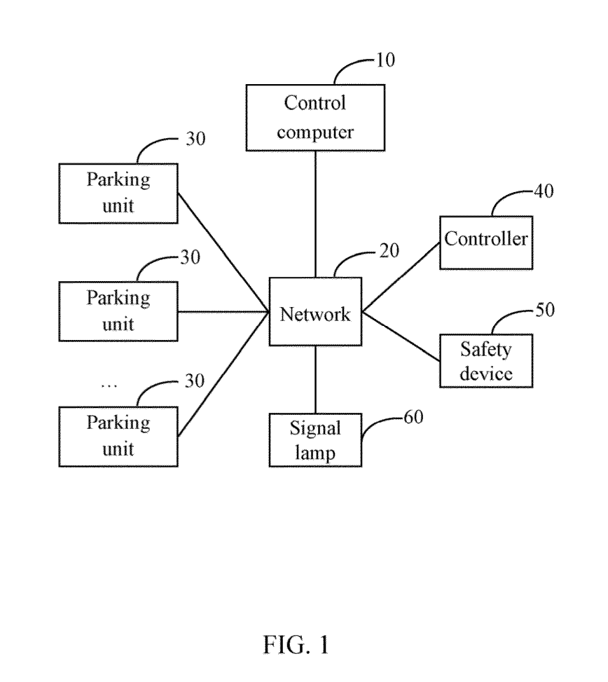

FIG. 1 is a schematic diagram of one embodiment of a control computer 10 electronically connected with a plurality of parking units (or “parking bays”) 30. In one embodiment, the control computer 10 is further connected to a controller 40, a safety device (e.g., a fuse socket) 50, and one or more signal lamps 60 (only one is shown in

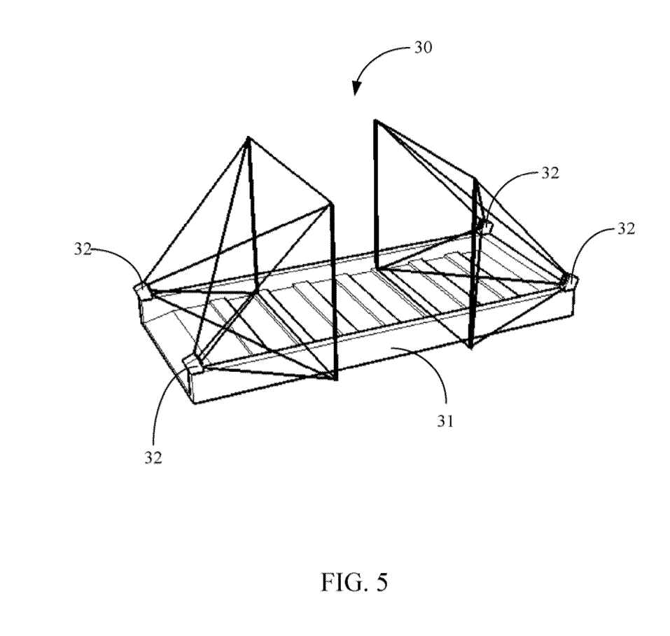

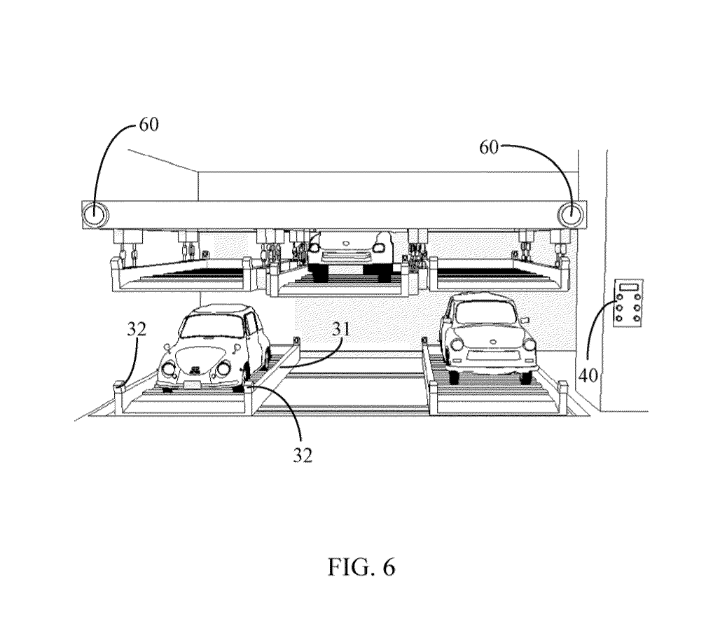

FIG. 1) through a network 20. In one embodiment, as shown in FIG. 5, one or more image capturing devices 32 are positioned on a carrier 31 of each parking unit 30. As shown in FIG. 6, the parking units 30, the controller 40, the safety device 50, and the signal lamp 60 constitute a mechanical parking system. The signal lamps 60 may be positioned above the parking units 30. The controller 40 is used to control movements of the parking units 30 so that a vehicle can move into one of the parking unit 30 or moved out or off from the parking unit 30.

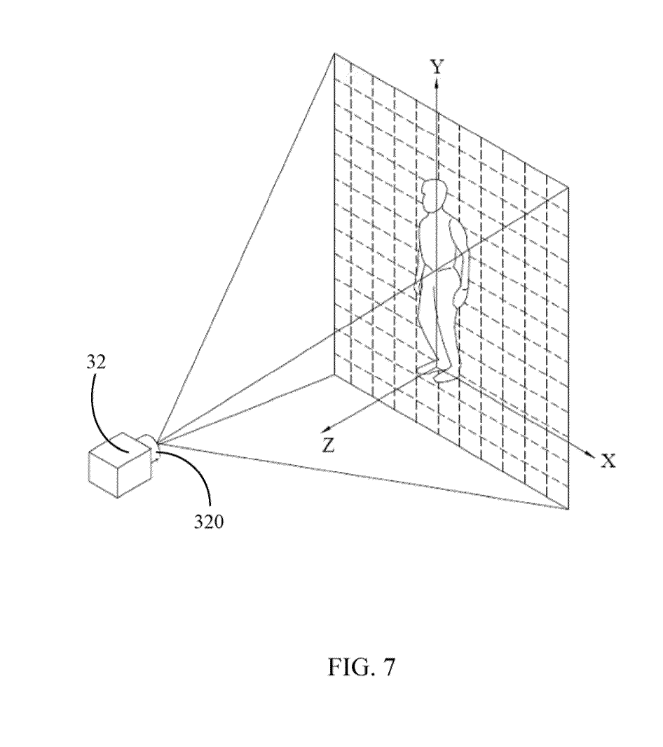

In one embodiment, the image capturing device 32 may be a depth-sensing camera, such as a time-of-flight (TOF) camera, for example as shown in FIG. 7. It is understood that, in this embodiment, the image capturing device 32 is a camera system that captures a distance from a target object in the scene being captured to a lens 320 of the image capturing device 32 (distance information) using the TOF principle, which can obtain a distance between the lens 320 and each point on a target object which has been captured. Thus, each image captured by the image capturing device 32 includes distance information between the lens 320 and each point on the object in the image.

In one embodiment, the image capturing devices 32 may be positioned on four corners (e.g., top corners) of the carrier 31 of each parking unit 30, to obtain digital images of a monitored area and send the digital images to the control computer 10 through the network 20. The control computer 10 controls the safety device 50 to cut off power supplies of the parking units 30 when a three dimensional (3D) figure area has been detected in one of the digital images, and outputs an alarm message by lighting the signal lamps 60. The network 20 may be an Intranet, the Internet or other suitable communication network. In other embodiments, the image capturing devices 32 may be positioned on other positions of the carrier 31.

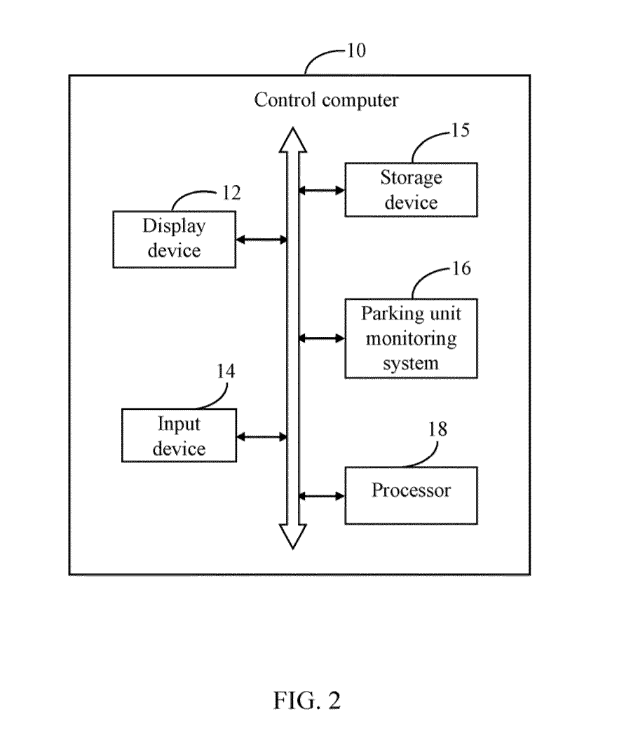

FIG. 2 is a block diagram of one embodiment of the control computer 10 including a parking unit monitoring system 16. The control computer 10 further includes a display device 12, an input device 14, a storage device 15, and at least one processor 18. It should be understood that FIG. 2 illustrates only one example of the control computer 10 that may include more or fewer components than illustrated, or a different configuration of the various components in other embodiments.

The display device 12 may be a liquid crystal display (LCD) or other display device, and the input device 14 may be a mouse, a keyboard, a touch screen, and/or a touchpad used to input computer readable data.

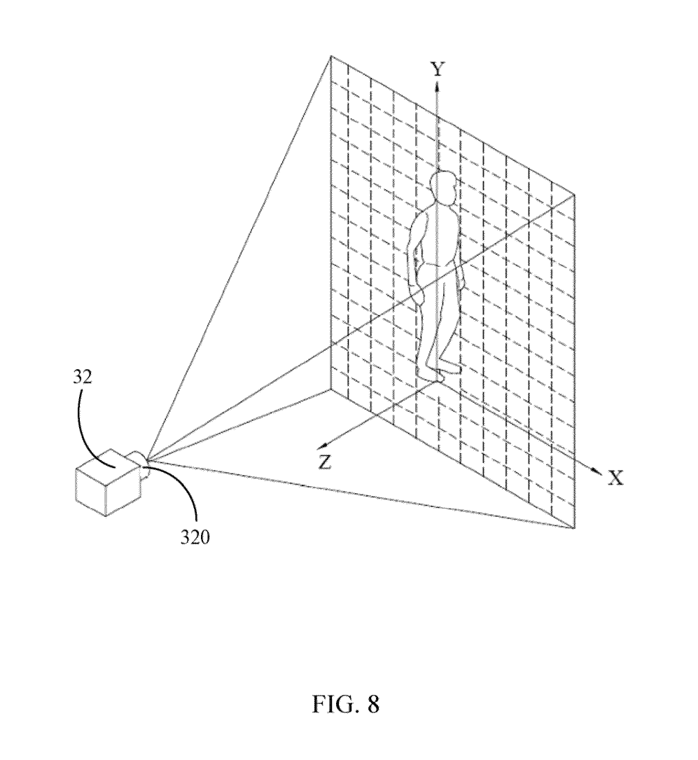

In one embodiment, the storage device 15 stores 3D figure images and 3D figure templates. The 3D figure images are captured by the image capturing devices 32. In one embodiment, the 3D figure images may include frontal images (as shown in FIG. 7) and side images (as shown in FIG. 8), for example. A frontal image of a person is an image captured when the image capturing device 32 is positioned in front of the person, and a side image of the person is an image captured when the image capturing device 32 is positioned at one side of the person. Depending on the embodiment, the storage device 15 may be a smart media card, a secure digital card, a compact flash card, or any other memory storage device.

The parking unit monitoring system 16 is used to receive the digital images (i.e., the 3D figure images) from the image capturing devices 32, and determine if the digital images include a 3D figure area, which is defined as an object that includes character points that can be used to construct an outline of a person. In this embodiment, the character points (such as the nose, the eyes) represent points that can be used to construct an outline of the person. If one of the digital images includes a 3D figure area, the parking unit monitoring system 16 controls the safety device 50 to cut off power supplies of the parking units 30, and outputs an alarm message by lighting the signal lamps 60. In one embodiment, the parking unit monitoring system 16 may include computerized instructions in the form of one or more programs that are executed by the at least one processor 18 and stored in the storage device 15 (or memory). A detailed description of the parking unit monitoring system 16 will be given in the following paragraphs.

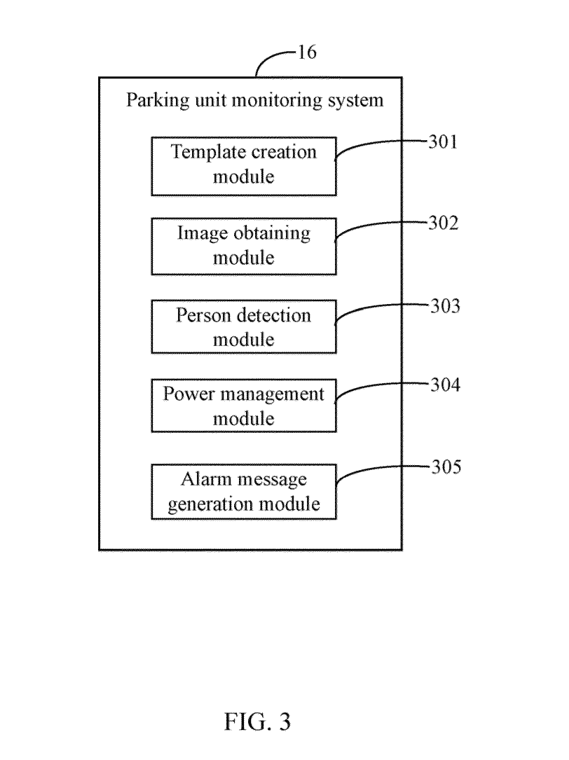

FIG. 3 is a block diagram of function modules of the parking unit monitoring system 16 included in the control computer 10. In one embodiment, the parking unit monitoring system 16 may include one or more modules, for example, a template creation module 301, an image obtaining module 302, a person detection module 303, a power management module 304, and an alarm message generation module 305. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

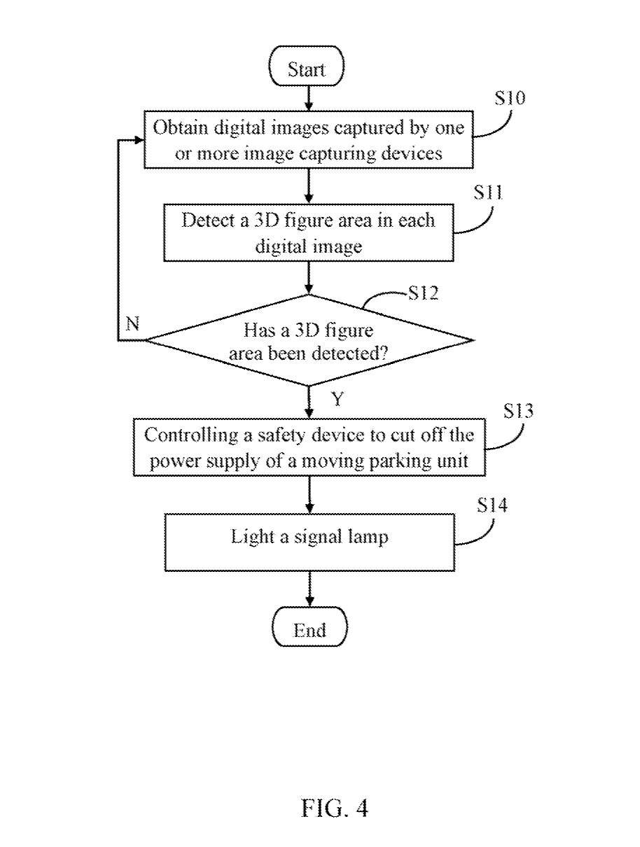

FIG. 4 is a flowchart of one embodiment of a method for monitoring safety of the parking units 30 moved in the mechanical parking system using the control computer 10. Depending on the embodiment, additional steps may be added, others removed, and the ordering of the steps may be changed.

Before describing the flowchart of FIG. 4, the template creation module 301 creates a 3D figure template for storing an allowable range of a pixel value of same character point according to the distance information in the 3D figure images. In some embodiments, the template creation module 301 reads a 3D figure image N1 (as shown in FIG. 8), obtains a distance between the lens 320 and each character point of the subject of the 3D figure image N1. For example, a distance between the lens 320 and the nose may be 61 cm, a distance between the lens 320 and the forehead may be 59 cm.

The template creation module 301 further converts each distance into a pixel value, for example, 61 cm may be converted to 255, and 59 cm may be converted to 253, and stores the pixel value of each character point into a character matrix of the 3D figure image. The character matrix is a data structure used for storing the pixel values of the character points in the 3D figure image. Furthermore, the template creation module 301 aligns all character matrices of the 3D figure images based on a predetermined character point, such as a center of the figure in each 3D figure image, and records pixel values of same character points in different character matrices into the 3D figure template. The pixel values of the same character point in different character matrices are regarded as the allowable range of the pixel value of the same character point. For example, an allowable range of the pixel value of the nose may be [251, 255], and an allowable range of the forehead may be [250, 254].

In block S10, when the mechanical parking system starts up (e.g., turns on), the image obtaining module 302 obtains digital images captured by one or more of the image capturing devices 32 positioned on the moving parking unit 30 of the mechanical parking system at each preset time interval (e.g., one second). In other embodiments, the image obtaining module 302 may obtain digital images captured by the image capturing device 32 positioned on all of the parking units 30.

In block S11, the person detection module 303 detects a 3D figure area in each digital image. In one embodiment, the 3D figure area is regarded as a person in a specified scene (e.g. a space near the moving parking unit 30). A detailed description is provided as follows.

First, the person detection module 303 converts a distance between the lens 320 and each point of the specified scene in the digital image into a pixel value of the point, and creates a character matrix of the digital image. Second, the person detection module 303 compares a pixel value of each point in the character matrix with a pixel value of a corresponding character point in the 3D figure template. Third, the person detection module 303 determines if the digital image has a 3D figure area by determining if an image sub-area (a sub-area of the digital image) has a first specified number (e.g., n1) of points in the digital image. In some embodiments, if a pixel value of each point in the image sub-area is within an allowance range of a corresponding character point in the 3D figure template, the person detection module 303 determines that the image sub-area is the 3D figure area in the digital image.

For example, a pixel value of the nose in the character matrix is compared with the pixel value of the nose in the 3D figure template. The 3D figure template may store a number Q1 of character points, and the first specified number may be set as Q1*80%. If the image sub-area exists in the digital image, the person detection module 303 determines that the image sub-area is a 3D figure area.

In block S12, the person detection module 303 determines if the 3D figure area has been detected in one of the digital images. If the 3D figure area has been detected in one of the digital images, the procedure goes to block S13. If the 3D figure area has not been detected in all of the digital images, the procedure returns to block S10.

In block S13, the power management module 304 controls the safety device 50 to cut off the power supply of the moving parking unit 30. In other embodiments, the power management module 304 may control the safety device 50 to cut off the power supplies of all the parking units 30 in the mechanical parking system.

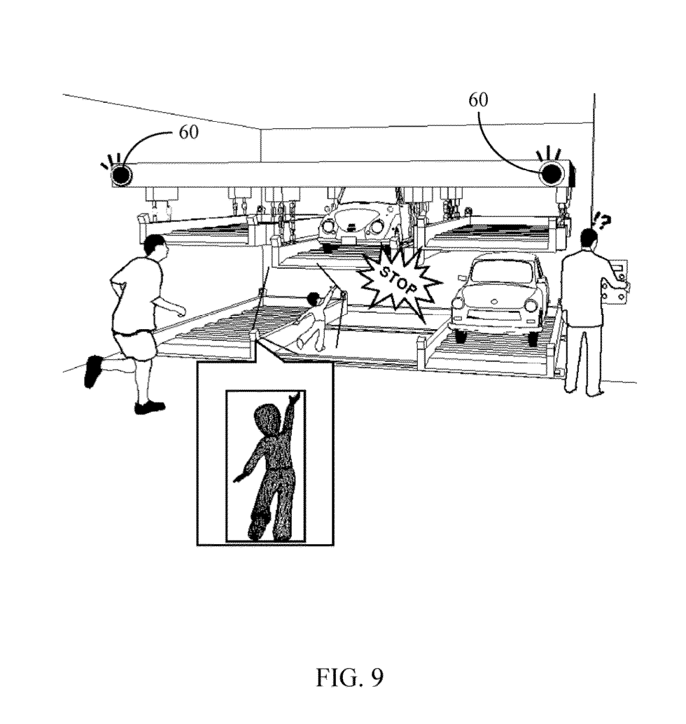

In block S14, the alarm message generation module 305 outputs alarm messages by lighting the signal lamps 60 (referring to FIG. 9). In this embodiment, if the moving parking unit 30 is stopped and the signal lamps 60 are lit, it is an indication that a person is close to the moving parking unit 30. If the moving parking unit 30 is stopped, but the signal lamps 60 are unlit, it is an indication that no-one is near the moving parking unit 30.

In other embodiments, the alarm message generation module 305 may output alarm messages using one or more buzzers or speakers of the control computer 10, where the buzzers or the speakers may be positioned on the controller 40.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented method for monitoring safety of a moving parking unit in a mechanical parking system using a control computer comprising a processor, the method comprising execution of the steps comprising:
obtaining digital images captured by one or more image capturing devices positioned on the moving parking unit;
detecting a three dimensional (3D) figure area in each of the digital images; and
cutting off power supplies of the moving parking unit using a safety device of the mechanical parking system upon the condition that the 3D figure area has been detected.

2. The method according to claim 1, further comprising: outputting alarm messages by lighting one or more signal lamps of the mechanical parking system.

3. The method according to claim 1, further comprising: outputting alarm messages using one or more buzzers or speakers of the mechanical parking system.

4. The method according to claim 1, further comprising: creating a 3D figure template that stores an allowable range of a pixel value of a character point according to a distance information in a plurality of 3D figure images captured by the image capturing devices.

5. The method according to claim 4, wherein the 3D figure template is created by:
reading a distance between a lens of an image capturing device and each character point of a subject of a pre-captured 3D figure image;
converting each distance into a pixel value, and storing the pixel value of each character point into a character matrix of the pre-captured 3D figure image; and
aligning all character matrices of the pre-captured 3D figure images based on a predetermined character point, and recording pixel values of same character points in different character matrices as the allowable range of the pixel value of the same character points.

6. The method according to claim 4, wherein the 3D figure area is detected by:
converting a distance between a lens of the image capturing device and each point in the digital image into a pixel value of the point, and creating a character matrix of the digital image;
comparing a pixel value of each point in the character matrix with a pixel value of a corresponding character point in a 3D figure template;
determining an image sub-area in the digital image being the 3D figure area upon the condition that the image sub-area has a first specified number of points existing in the digital image, a pixel value of each point in the image sub-area being within an allowance range of a corresponding character point in the 3D figure template; and
determining that the 3D figure area has been detected in the digital image.

7. A control computer, comprising:
a storage device;
at least one processor; and
one or more modules that are stored in the storage device and are executed by the at least one processor, the one or more modules comprising:
an image obtaining module that obtains digital images captured by one or more image capturing devices positioned on a moving parking unit of a mechanical parking system;
a person detection module that detects a three dimensional (3D) figure area in each of the digital images; and
a power management module that cuts off power supplies of the moving parking unit using a safety device of the mechanical parking system upon the condition that the 3D figure area has been detected.

8. The control computer according to claim 7, wherein the one or more modules further comprise: an alarm message generation module that outputs alarm messages by lighting one or more signal lamps of the mechanical parking system.

9. The control computer according to claim 7, wherein the one or more modules further comprise: an alarm message generation module that outputs alarm messages using one or more buzzers or speakers of the mechanical parking system.

10. The control computer according to claim 7, wherein the one or more modules further comprise: a template creation module that creates a 3D figure template that stores an allowable range of a pixel value of a character point according to a distance information in a plurality of 3D figure images captured by the image capturing devices.

11. The control computer according to claim 10, wherein the 3D figure template is created by:
reading a distance between a lens of an image capturing device and each character point of a subject of a pre-captured 3D figure image;
converting each distance into a pixel value, and storing the pixel values of each character point into a character matrix of the pre-captured 3D figure image; and
aligning all character matrices of the pre-captured 3D figure images based on a predetermined character point, and recording pixel values of same character points in different character matrices as the allowable range of the pixel value of the same character points.

12. The control computer according to claim 10, wherein the 3D figure area is detected by:
converting a distance between a lens of the image capturing device and each point in the digital image into a pixel value of the point, and creating a character matrix of the digital image;
comparing a pixel value of each point in the character matrix with a pixel value of a corresponding character point in a 3D figure template;
determining an image sub-area in the digital image being a 3D figure area upon the condition that the image sub-area has a first specified number of points existing in the digital image, a pixel value of each point in the image sub-area being within an allowance range of a corresponding character point in the 3D figure template; and
determining that the 3D figure area has been detected in the digital image.

13. A non-transitory storage medium having stored thereon instructions that, when executed by a processor of a control computer, causes the control computer to perform a method for monitoring safety of a moving parking unit in a mechanical parking system, the method comprising:
obtaining digital images captured by one or more image capturing devices positioned on the moving parking unit;
detecting a three dimensional (3D) figure area in each of the digital images; and
cutting off power supplies of the moving parking unit using a safety device of the mechanical parking system upon the condition that the 3D figure area has been detected.

14. The non-transitory storage medium according to claim 13, wherein the method further comprises: outputting alarm messages by lighting one or more signal lamps of the mechanical parking system.

15. The non-transitory storage medium according to claim 13, wherein the method further comprises: outputting alarm messages using one or more buzzers or speakers of the mechanical parking system.

16. The non-transitory storage medium according to claim 13, wherein the method further comprises: creating a 3D figure template that stores an allowable range of a pixel value of a character point according to a distance information in a plurality of 3D figure images captured by the image capturing devices.

17. The non-transitory storage medium according to claim 16, wherein the 3D figure template is created by:
reading a distance between a lens of an image capturing device and each character point of a subject of a pre-captured 3D figure image;
converting each distance into a pixel value, and storing the pixel value of each character point into a character matrix of the pre-captured 3D figure image; and
aligning all character matrices of the pre-captured 3D figure images based on a predetermined character point, and recording pixel values of same character points in different character matrices as the allowable range of the pixel value of the same character points.

18. The non-transitory storage medium according to claim 16, wherein the 3D figure area is detected by:
converting a distance between a lens of the image capturing device and each point in the digital image into a pixel value of the point, and creating a character matrix of the digital image;
comparing a pixel value of each point in the character matrix with a pixel value of a corresponding character point in a 3D figure template;
determining an image sub-area in the digital image being the a 3D figure area upon the condition that the image sub-area has a first specified number of points existing in the digital image, a pixel value of each point in the image sub-area being within an allowance range of a corresponding character point in the 3D figure template; and
determining that the 3D figure area has been detected in the digital image.

19. The non-transitory storage medium according to claim 13, wherein the medium is selected from the group consisting of a hard disk drive, a compact disc, a digital video disc, and a tape drive.
